(19) United States
(12) Patent Application Publication
(10) Pub. No.: US 2018/0065123 A1
(43) Pub. Date: Mar. 8, 2018

(54) FILM TREATMENT SYSTEM

(71) Applicant: Geo-Tech Polymers, LLC, Westerville, OH (US)

(72) Inventors: Stephen Craig Tackett, Greenup, KY (US); Ronald Lee Whaley, Monmouth, IL (US); Dennis Ray Tackett, Westerville, OH (US); Sreevalli Bokka, Chillicothe, OH (US); Travis Scott Nickel, Raceland, KY (US)

(21) Appl. No.: 15/693,639

(22) Filed: Sep. 1, 2017

Related U.S. Application Data
(60) Provisional application No. 62/383,645, filed on Sep. 6, 2016.

(51) Int. Cl. B02C 18/08; B02C 18/18; B02C 23/36

(52) U.S. Cl. CPC B02C 18/086; B02C 23/36; B02C 18/18

(57) ABSTRACT

A film treatment system includes a mill tank, a shaft, and a milling blade. The mill tank contains coated polymeric material in comminuted form, and further contains an aqueous solution for removing coating material from the polymeric material. The shaft is supported for rotation about a vertical axis in the tank. The milling blade is supported on the shaft for rotation with the shaft, and has a leading surface reaching radially outward with a convex contour facing in a rotationally forward direction.

### RELATED APPLICATIONS

This application claims priority of provisional U.S. patent application 62/383,645 filed Sep. 6, 2016, which is incorporated by reference.

### TECHNICAL FIELD

This technology relates to the removal of undesirable coatings from polymeric films in preparation for recycling.

### BACKGROUND

Polymeric films to be recycled may have coatings that are undesirable in the recycled material. For example, such coatings may include inks, labels, adhesives, metallic films, and the like, as used in packaging or manufacture of personal care products such as diapers and diaper packaging. It may be desirable to process the polymeric films to remove the undesirable coatings prior to further uses of the films, such as recycled feed stocks for remanufactured plastics.

### SUMMARY

Each of the following summary paragraphs describes an example of how the invention may be implemented as a combination of elements. Any one or more of the elements of each summary paragraph may be utilized with any or more of the distinct elements of another.

In a particular embodiment, the film treatment system includes a mill tank, a shaft, and a milling blade. The mill tank contains coated polymeric material in comminuted form, and further contains an aqueous solution for removing coating material from the polymeric material. The shaft is supported for rotation about a vertical axis in the tank. The milling blade is supported on the shaft for rotation with the shaft, and has a leading surface reaching radially outward with a convex contour facing in a rotationally forward direction.

The milling blade may have a plurality of stirring vanes projecting radially outward. Each vane may have a leading surface with a convex contour facing in a rotationally forward direction. Each vane may further have a trailing surface with a concave contour facing in a rotationally rearward direction toward an opposed one of the leading surfaces.

In a given example, a plurality of milling blades are supported on the shaft for rotation with the shaft. These include first blades and a second blade. Each of the first blades has a disc-shaped base portion with a circular periphery, and further has circumferentially elongated stirring portions projecting vertically from the periphery of the base portion. The second blade has a plurality of vanes projecting radially outward. Each vane has a leading surface with a convex contour facing in a rotationally forward direction. Each vane also has a trailing surface with a concave contour facing in a rotationally rearward direction toward an opposed one of the leading surfaces. The second blade may be arranged as the lowermost milling blade on the shaft.

### BRIEF DESCRIPTION OF THE DRAWINGS

FIG. 1 is a schematic view of components of a system for the treatment of coated plastic film material.

FIG. 2 is a schematic showing additional components of the system of FIG. 1.

FIG. 3 also is a schematic view showing additional components of the system of FIG. 1.

FIG. 4 is a detailed schematic view of a component shown in FIG. 1.

FIG. 5 is also is detailed schematic view of another component shown in FIG. 1.

FIG. 6 is a top view of a part shown in FIG. 5.

FIG. 7 is a sectional view of the part shown in FIG. 6.

FIG. 8 is a top view of another part shown in FIG. 5.

FIG. 9 is a side view of the part shown in FIG. 8.

### DETAILED DESCRIPTION

The system illustrated in the drawings can be operated as recited in the method claims, and has components that are examples of the elements recited in the apparatus claims. The illustrated system thus includes examples of how a person of ordinary skill in the art can make and use the claimed invention. It is described here to meet the enablement and best mode requirements of the patent statute without imposing limitations that are not recited in the claims.

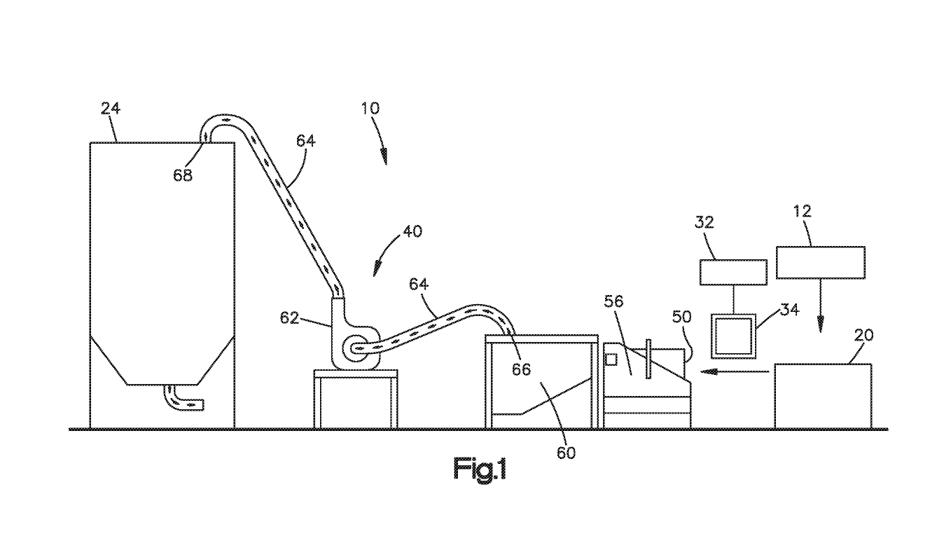

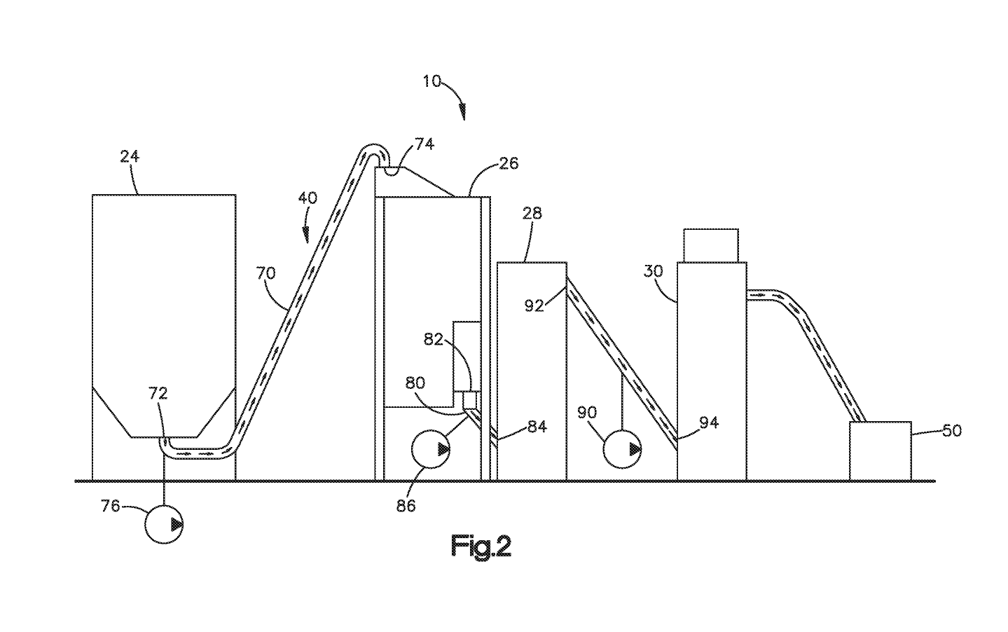

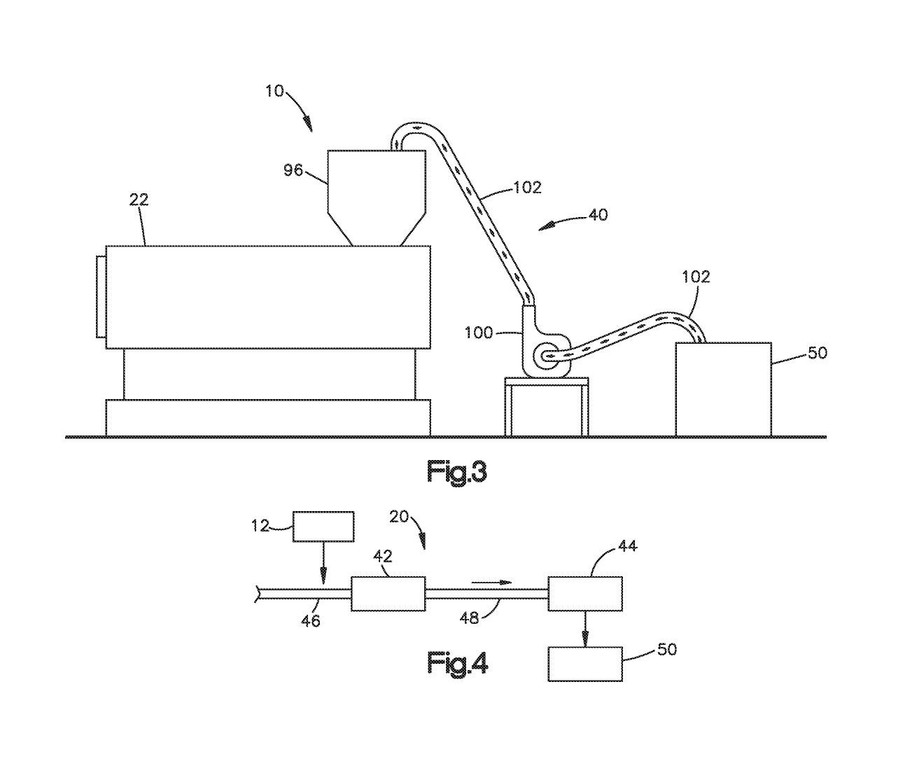

As shown in FIGS. 1-3, a system 10 is provided for the treatment of coated polymeric film material 12. The system 10 has components arranged as successive processing stations at which the film material 12 is treated. These include a comminuting device 20 at one end of the system 10, as shown in FIG. 1, and an extruder 22 at the opposite end of the system 10, as shown in FIG. 3. Intermediate processing stations are defined by a mill tank 24 (FIGS. 1 and 2), as well as a dump tank 26, a washer 28, and a dryer 30 (FIG. 2). The components 20-30 may be interconnected to operate under the control of a PLC 32 with a monitor 34.

A conveyance subsystem 40 reaches through the system 10 to advance the film material 12 between successive processing stations, also under control of the PLC 32. As further shown in the drawings, the conveyance subsystem 40 includes conduits and pumps that convey the film material 12 between successive processing stations in streams of conveyance fluid.

The coated polymeric film material 12 is obtained from a manufacturer or other source of recyclable material, and is typically provided in bales of separate pieces, such as bags, or in rolls of continuous pieces. The film material 12 may also be provided as a collection of separate pieces of scrap material having a range of differing sizes and shapes. In each case, the film material 12 is inherently flexible and tends to deform, such as by crimping or tangling, more easily than relatively thick-walled plastic pieces such as bottles and the like. Accordingly, the film material 12 is shredded, granulated, or otherwise comminuted in the comminuting device 20 before being advanced further through the system 10. This reduces the sizes of separate pieces of the film material 12, and also renders them more uniformly sized and shaped, so that the comminuted film material 12 is flowable through the system without becoming tangled or jammed.

As shown in greater detail FIG. 4, the comminuting device 20 in the given example includes both a shredder 42 and a granulator 44. The film material 12 is placed on a conveyor 46 that takes the film material 12 to the shredder 42, or the film material may alternatively be placed directly into the shredder 42. The shredder 42 cuts the film material 12 into smaller pieces, and dumps the cut film material 12 onto another conveyor 48 that takes it to the granulator 44.

Once the cut film material is in the granulator 44, it is size-reduced to a specified size based on the material and application. Different size screens in the granulator 44 allow the cut film material 12 to be reduced to different sizes. The screens sort the granulated film material 12 and allow it to fall into receptacles 50 such as boxes or bags, or into a pump, once it is reduced to the size needed.

Referring again to FIG. 1, a box 50 of the granulated film material 12 is loaded into a box dumper 56, which dumps the granulated film material 12 into a receptacle 60. The conveyance subsystem 40 includes a light material feed pump 62 in a conduit 64. The conduit 64 has an inlet 66 at the receptacle 60, and has an outlet 68 at the mill tank 24. The pump 62 drives a stream of conveyance air that blows the granulated film material 12 through the conduit 64 from the receptacle 60 into the mill tank 24.

The mill tank 24 contains an aqueous solution for removing coating material from the granulated film material 12. The aqueous solution may have any suitable composition known in the art, and may alternatively have a composition as described in any one or more of the following U.S. Patent Applications, each of which is incorporated by reference:

U.S. patent application Ser. No. 14/830,529, filed Aug. 19, 2015.

U.S. patent application Ser. No. 14/830,639, filed Aug. 19, 2015.

U.S. patent application Ser. No. 14/830,626, filed Aug. 19, 2015.

U.S. patent application Ser. No. 14/830,614, filed Aug. 19, 2015.

U.S. patent application Ser. No. 15/049,105, filed Feb. 21, 2016.

U.S. patent application Ser. No. 15/049,106, filed Feb. 21, 2016.

U.S. patent application Ser. No. 15/049,107, filed Feb. 21, 2016.

The aqueous solution in the mill tank 24 is preferably heated before the granulated film material 12 is inserted. The mill tank 24 has an agitator, such as a shaft with three blades, that stir and mix the contents. This provides heat, friction, and chemicals that together remove the coating material from the granulated film material 12.

Samples of the granulated film material 12 are taken out of the mill tank 24 periodically to perform a contaminant count, to determine parts per million of coating on the plastic, until the material passes inspection. Usually the initial sample is weighed, then the coated pieces are pulled out and reweighed. Then a calculation using both weights is performed to determine the parts per million that are still coated.

As shown in FIG. 2, the conveyance subsystem 40 in the illustrated example further includes a conduit 70 with an inlet 72 at the mill tank 24 and an outlet 74 at the dump tank 26. Once the granulated film material 12 passes inspection at the mill tank 24, it is conveyed through the conduit 70 from the mill tank 24 to the dump tank 26. A pump 76 uses the aqueous fluid in the mill tank 24 as the conveyance fluid for this movement of the granulated film material 12.

The dump tank 26 strains the aqueous solution from the granulated film material 12. Specifically, the granulated film material 12 goes across a screen where the water and chemicals drain into a separate section of the dump tank 26. Once the material goes across the screen it falls into a larger section of the dump tank 26.

There are a few ways to feed the material through the dump tank 26 into the next phase of the process. One way is to use an auger to push the material through the bottom of the tank. Also a rotary valve can be used with the auger system to help push material through the tank. If the auger is used, water is sprayed onto the auger and material to keep the plastic wet, to allow the auger to push the material. Another way to move the material through the dump tank 26 is to remove the rotary valve at the bottom of the tank, and have the operator use a manual slide to regulate the flow rate of the material.

Once the granulated film material 12 is pumped out of the dump tank 26, it goes into the washer 28, which washes all the chemicals off the plastic and rinses it with water. In the illustrated example, the conveyance subsystem 40 includes a conduit 80 having an inlet 82 in the dump tank 26, an outlet 84 at the washer 28, and a pump 86 for driving the granulated film material 12 through the conduit 80.

Next, a pump 90 drives the granulated film material 12 through a conduit 90 having an inlet 92 at the washer 28 and an outlet 94 at the dryer 30. Finally, the cleaned and dried granulated film material is pushed out of the dryer 30 and into receptacles 50 for transportation to the extruder 22.

The extrusion phase is started by pumping the cleaned, dried granulated film material 12 out of the receptacles 50 and into a hopper 96 at the extruder 22. In the illustrated example, this is accomplished by a pump 100 in a conduit 102 in substantially the same manner that the coated granulated film material 12 is delivered to the mill tank 24 by the pump 62 and conduit 64 described above with reference to FIG. 1. Once the material is loaded into the hopper 96, it is fed into the extruder 22. The material is extruded using the appropriate speeds and temperature for the material. As the material is extruded, it is made into small round pellets using an underwater pelletizer. The pellets are then pumped through pipes into a drying system and then into boxes, ready for inspection.

FIG. 5 shows an example of an agitator 120 for use with the mill tank 24. In this example, the agitator 120 includes a shaft 124 with a vertical axis 125. A gantry assembly 126 supports the shaft 124 from above the tank 24, and has a motor 128 for rotating the shaft 124 about the axis 125. The gantry assembly 126 may be further configured to move the rotating shaft 124 back and forth in opposite directions extending across the inside of the tank 24, as indicated by the arrows shown in the drawing. Milling blades 130 are supported on the shaft 124 to rotate and move back and forth with the shaft 124.

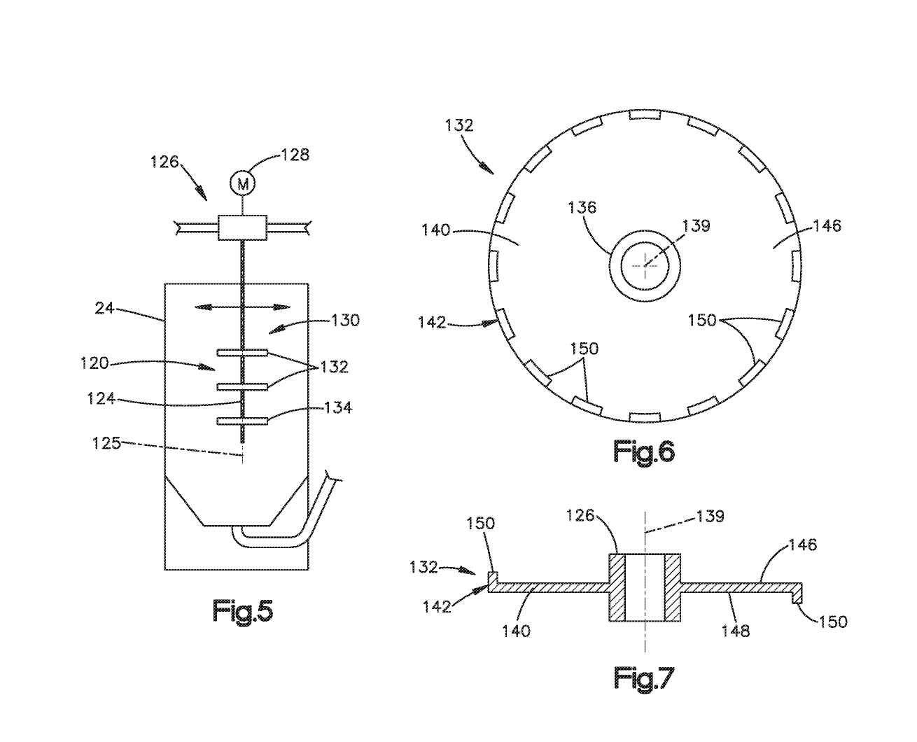

The milling blades 130 in the given example include a pair of upper blades 132 and a single lower blade 134 beneath the upper blades 132. The upper blades 132 are preferably alike, with each having the configuration shown for example in FIGS. 6 and 7. Each upper blade 132 in the given example thus has a hub 136 with a central axis 139, and further has disc-shaped base 140 with a circular periphery 142 centered on the axis 139. The hub 136 is received coaxially over the shaft 124. The base 140 has planar opposite side surfaces 146 and 148 reaching horizontally outward from the hub 136 to the periphery 142. An array of stirring portions 150 are located at the periphery 142. The stirring portions 150 are elongated circumferentially about the periphery 142, and project axially upward and downward from the periphery 142 in an alternating arrangement.

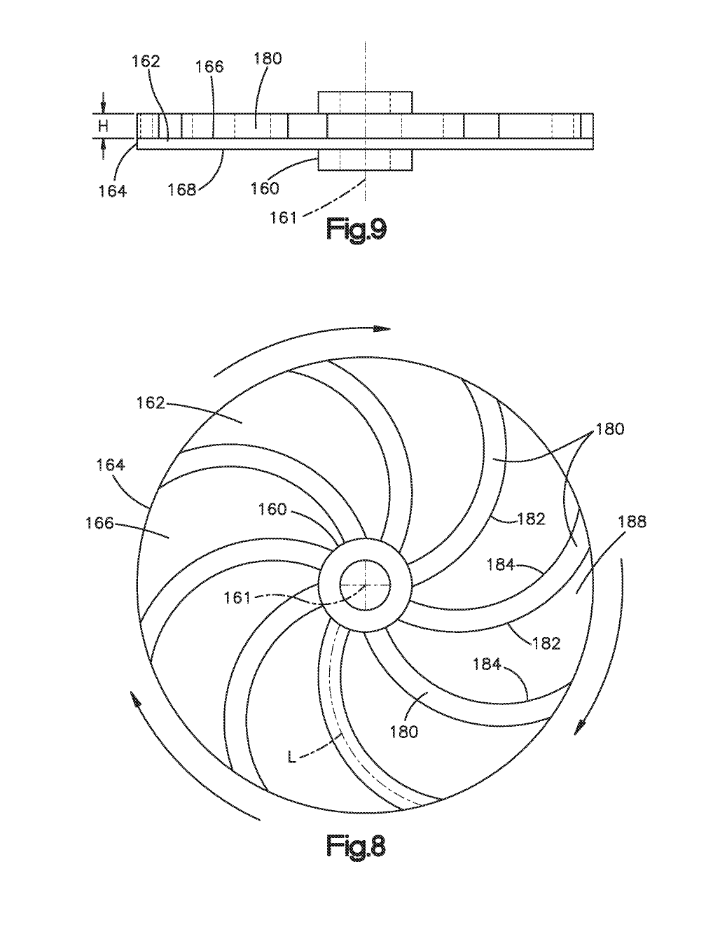

In the example shown in FIGS. 8 and 9, the lower blade 134 also has a hub 160 with a central axis 161 and a disc-shaped base 162 with a circular periphery 164 centered on the axis 161. The hub 160 of the lower blade 134 is received coaxially over the shaft 124. The base 162 has planar opposite side surfaces 166 and 168 reaching horizontally outward from the hub 160 to the periphery 164.

In the illustrated example, the lower blade 134 further has a plurality of stirring vanes 180. The vanes 180 project axially upward from the upper side surface 166 of the base 162. The vanes 180 also project radially outward in arcuate configurations from the hub 160 to the periphery 164. As shown, the blades 180 have equal curvatures, equal lengths L, and equal heights H that are uniform along their lengths L. Each vane 180 has a leading surface 182 with a convex contour facing in a rotationally forward direction. Each vane 180 further has a trailing surface 184 with a concave contour facing in a rotationally rearward direction toward an opposed one of the leading surfaces 182.

In the configuration shown in FIG. 8, the vanes 180 delineate distinct upper side surface portions 188 of the base 162. Each of those upper side surface portions 188 reaches radially outward between one of the leading surfaces 182 and an opposed one of the trailing surfaces 184. Each of those upper side surface portions 188 also reaches circumferentially from the adjacent leading surface 182 to the adjacent trailing surface 184.

This written description sets for the best mode of carrying out the invention, and describes the invention so as to enable a person of ordinary skill in the art to make and use the invention, by presenting examples of the elements recited in the claims. The detailed descriptions of those elements do not impose limitations that are not recited in the claims, either literally or under the doctrine of equivalents.

What is claimed is:

1. An apparatus comprising:
a mill tank containing coated polymeric material in comminuted form, and further containing an aqueous solution for removing coating material from the polymeric material;
a shaft supported for rotation about a vertical axis in the tank; and
a milling blade supported on the shaft for rotation with the shaft, the milling blade having a leading surface reaching radially outward with a convex contour facing in a rotationally forward direction.

2. An apparatus as defined in claim 1 wherein leading surface is elongated with radially extending length and axially extending height.

3. An apparatus as defined in claim 2 wherein the height is uniform throughout the length.

4. An apparatus as defined in claim 1 wherein the blade further has a trailing surface that is spaced circumferentially from the leading surface in the rotationally forward direction, and the trailing surface reaches radially outward with a concave contour facing in a rotationally rearward direction toward the leading surface.

5. An apparatus as defined in claim 4 wherein the blade further has a horizontal base surface reaching radially outward between leading surface and the trailing surface.

6. An apparatus as defined in claim 5 wherein the horizontal base surface reaches circumferentially from the leading surface to the trailing surface.

7. An apparatus as defined in claim 5 wherein the leading surface and the trailing surface project upward from the horizontal base surface.

8. An apparatus comprising:
a mill tank containing coated polymeric material in comminuted form, and further containing an aqueous solution for removing coating material from the polymeric material;
a shaft supported for rotation about a vertical axis in the tank; and
a milling blade supported on the shaft for rotation with the shaft;
wherein the blade has a plurality of vanes projecting radially outward, each vane has a leading surface with a convex contour facing in a rotationally forward direction, and each vane further has a trailing surface with a concave contour facing in a rotationally rearward direction toward an opposed one of the leading surfaces.

9. An apparatus as defined in claim 8 wherein each leading surface is elongated with radially extending length and axially extending height.

10. An apparatus as defined in claim 9 wherein the height of each leading surface is uniform throughout the respective length.

11. An apparatus as defined in claim 8 wherein the blade further has a plurality of horizontal base surface portions, each of which reaches radially outward between one of the leading surfaces and an opposed one of the trailing surfaces.

12. An apparatus as defined in claim 11 wherein each horizontal base surface portion reaches circumferentially from one of the leading surfaces to an opposed one of the trailing surfaces.

13. An apparatus as defined in claim 11 wherein the leading surfaces and the trailing surfaces project upward from the horizontal base surface portions.

14. An apparatus comprising:
a mill tank containing coated polymeric material in comminuted form, and further containing an aqueous solution for removing coating material from the polymeric material;
a shaft supported for rotation about a vertical axis in the tank; and
a plurality of milling blades supported on the shaft for rotation with the shaft, including a first blade and a second blade;
wherein the first blade has a disc-shaped base portion with a circular periphery, and further has circumferentially elongated stirring portions projecting vertically from the periphery of the base portion; and
wherein the second blade has a plurality of vanes projecting radially outward, each vane has a leading surface with a convex contour facing in a rotationally forward direction, and each vane further has a trailing surface with a concave contour facing in a rotationally rearward direction toward an opposed one of the leading surfaces.

15. An apparatus as defined in claim 14 wherein the first blade is located on the shaft above the second blade.

16. An apparatus as defined in claim 14 wherein the first blade is one of a plurality of blades that are alike and are located above the second blade.

17. An apparatus as defined in claim 16 wherein the second blade is a lowermost blade on the shaft.

18. An apparatus as defined in claim 14 wherein each leading surface is elongated with radially extending length and axially extending height.

19. An apparatus as defined in claim 18 wherein the height of each leading surface is uniform throughout the respective length.

20. An apparatus as defined in claim 14 wherein the second blade further has a plurality of horizontal base surface portions, each of which reaches radially outward between one of the leading surfaces and an opposed one of the trailing surfaces.

21. An apparatus as defined in claim 20 wherein each horizontal base surface portion reaches circumferentially from one of the leading surfaces to an opposed one of the trailing surfaces.

22. An apparatus as defined in claim 20 wherein the leading surfaces and the trailing surfaces project upward from the horizontal base surface portions.
